(19) United States
(12) Patent Application Publication
(10) Pub. No.: US 2009/0077509 A1
(43) Pub. Date: Mar. 19, 2009

(54) METHOD FOR CONTROLLING SHEET RESISTANCE OF POLY IN FABRICATION OF SEMICONDUCTOR DEVICE

(75) Inventor: Nan Soon CHOI, Seoul (KR)

Correspondence Address: Workman Nydegger;1000 Eagle Gate Tower, 60 East South Temple, Salt Lake City, UT, 84111, US

(73) Assignee: DONGBU HITEK CO., LTD., Seoul (KR)

(21) Appl. No.: 12/204,676

(22) Filed: Sep. 4, 2008

(30) Foreign Application Priority Data
Sep. 19, 2007 (KR) 10-2007-0095272

(51) Int. Cl. G06F 17/50

(52) U.S. Cl. 716/4

(57) ABSTRACT

A method for controlling the sheet resistance of poly in the fabrication of a semiconductor device. In one example embodiment, a method for controlling the sheet resistance of a poly in the fabrication of a semiconductor device includes various steps. First, detection is made whether or not an N-ion implantation area and a resistance area overlap with each other within the layout of a cell to be formed on a semiconductor wafer. Next, an LDD dummy area is generated in the area on the layout where the N-ion implantation area exists if such overlap is found. Then, detection is made whether or not a P-ion implantation area and a resistance area overlap with each other within the layout. Finally, an LDD dummy area is generated in the area on the layout where the P-ion implantation area exists if such overlap is found.

### CROSS-REFERENCE TO A RELATED APPLICATION

This application claims the benefit of Korean Patent Application No. 10-2007-0095272, filed on Sep. 19, 2007 which is hereby incorporated by reference as if fully set forth herein.

### BACKGROUND

1. Field of the Invention

Embodiments of the present invention relate to methods for fabricating a semiconductor device, and more particularly, to methods for accurately controlling the sheet resistance of non-salicide.

2. Description of the Related Art

Typically, a lightly doped drain (LDD) structure is employed in order to reduce a hot carrier effect by decreasing relatively small electrical fields. An LDD structure may be employed, for example, in a 130 nm process. In an LDD structure, an LDD dummy layer controls the sheet resistance of the poly by permitting an LDD ion implantation on a poly pattern upon formation of a resistance pattern.

In order to determine whether or not an LDD ion implantation has actually been performed, a test may be carried out to calculate the change in resistance by drawing an LDD dummy layer in a scribe line test pattern (SLTP). The LDD dummy layer may correspond to a poly resistance pattern and a resistance of an active area in which the source/drain are formed pursuant to the design rule of the aforementioned 130 nm process. As a result of the test using the SLTP, it can be determined that the difference in the resistance value for a salicide P-active sheet resistance pattern is not large if no LDD ion implantation is performed, while it can be seen that the resistance value for a non-salicide N-poly sheet resistance pattern becomes too large relative to design specifications if no LDD ion implantation is performed.

Accordingly, since the difference in the resistance value for the salicide P-active sheet resistance pattern is not large, the current state is maintained. On the other hand, in order to match the sheet resistance for the non-salicide N-poly sheet resistance pattern to the design specifications, a mask data preparation (MDP) generation rule should be changed during the MDP depending on a cell library so that an LDD ion implantation is performed on the region where an LDD dummy layer is present. However, when generating an LDD dummy layer using the MDP generation rule, the LDD ion implantation is performed even on an undesired region since the LDD dummy layer is generated even in an undesired pattern on the layout of a semiconductor wafer.

If the LDD dummy layer is drawn in the poly resistance pattern, no LDD ion implantation (for example, LV NMOS LDD ion implantation, HV NMOS LDD ion implantation, LV PMOS LDD ion implantation, or HV PMOS LDD ion implantation) is performed in the poly area, but only NMOS Source Drain(N++) or PMOS Source Drain(P++) ion implantation is performed. That is, in the case that an LDD dummy layer is generated by using the MDP generation rule in order to meet the sheet resistance of the poly resistor, no LDD ion implantation is performed in the poly area in which an LDD dummy layer is generated, thereby generating a significant difference in resistance.

Therefore, there is a demand for a method for more accurately controlling a sheet resistance of a poly by efficiently overcoming a significant difference that is generated depending on the presence of an LDD dummy layer as described above.

### SUMMARY OF EXAMPLE EMBODIMENTS

In general, example embodiments of the present invention relate to methods for controlling the sheet resistance of a poly in the fabrication of a semiconductor device. Some example embodiments of the invention result in a more accurate resistance value in the semiconductor device. Some example embodiments of the present invention programmably generate a lightly doped drain (LDD) dummy layer directly on the layout of a semiconductor wafer without generating the LDD dummy layer according to an MDP generation rule. Accordingly, some example embodiments of the present invention help solve the prior art problem of LDD ion implantation being performed even in an undesired region due to an LDD dummy layer generated in a undesired pattern if the MDP generation rule is used.

In one example embodiment, a method for controlling the sheet resistance of a poly in the fabrication of a semiconductor device includes various steps. First, detection is made whether or not an N-ion implantation area and a resistance area overlap with each other within the layout of a cell to be formed on a semiconductor wafer. Next, the area of an LDD dummy layer is generated in the area where the N-ion implantation area exists on the layout if such overlap is found. Then, detection is made whether or not a P-ion implantation area and a resistance area overlap with each other within the layout. Finally, the area of the LDD dummy layer is generated in the area where the P-ion implantation area exists on the layout if such overlap is found.

In another example embodiment, another method for controlling the sheet resistance of a poly in the fabrication of a semiconductor device includes various steps. First, a cell list is extracted from an I/O cell library. Next, all tree-shaped sub-cells of each cell are retrieved to detect whether or not an ion implantation area and a resistance area overlap with each other. Finally, the area of an LDD dummy layer is generated in the area where the ion implantation exists.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1 discloses an example operational control flow for programmably generating an LDD dummy area;

FIG. 2 discloses an example layout of a semiconductor wafer in which an LDD dummy area is generated;

FIG. 3 discloses an example operational control flow chart for automatically generating an example LDD dummy area on an I/O library; and

FIG. 4 discloses a layout of a prior art semiconductor wafer.

### DETAILED DESCRIPTION OF EXAMPLE EMBODIMENTS

In the following detailed description of the embodiments, reference will now be made in detail to specific embodiments of the present invention, examples of which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

In general, example embodiments of the present invention relate to methods for controlling the sheet resistance of a poly in the fabrication of a semiconductor device. Some example embodiments of the present invention result in a more accurate resistance value in the semiconductor device by automatically generating a lightly doped drain (LDD) dummy layer only on the area where an N-ion or P-ion implantation layer exists directly on the layout of a semiconductor device. Furthermore, some example embodiments of the present invention have an improved yield by programmably drawing an LDD dummy layer directly on the layout of a semiconductor wafer.

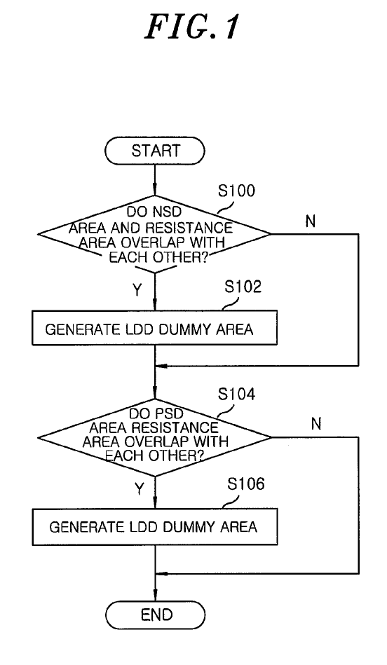

FIG. 1 discloses an example operational control flow for generating an LDD dummy area on the layout of a semiconductor wafer. A resistance pattern overlapped with a tag layer, referred to as “RESIST”, is detected in order to extract an active area and a poly resistor area so that the LDD dummy area is not generated in the area in which there is no actual resistance. In order to generate an LDD dummy area in the area where an NMOS Source Drain (NSD) area or PMOS Source Drain (PSD) to be implanted with N-ion or P-ion, respectively, exists on a semiconductor wafer, the generation of an LDD dummy area is programmably performed. In other words, if a command for generating an LDD dummy area is issued, the LDD dummy area generation program determines whether or not an NSD area and a resistance area overlap with each other on the layout of the semiconductor wafer (S100), and if such overlap is found, then an LDD dummy area is programmably generated in the area where the NSD area exists (S102).

Next, when the generation of an LDD dummy area is completed on the layout of the semiconductor wafer, it is determined whether or not a PSD area and the resistance area overlap with each other on the layout of the semiconductor wafer (S104), and if such overlap is found, then an LDD dummy area is programmably generated in the area where the PSD area exists (S106).

Accordingly, it is possible to match the sheet resistance of a poly relatively close to design specifications by performing LDD ion implantation by the LDD dummy area generated in the area where the NSD area or the PSD area exists on the layout of the semiconductor wafer.

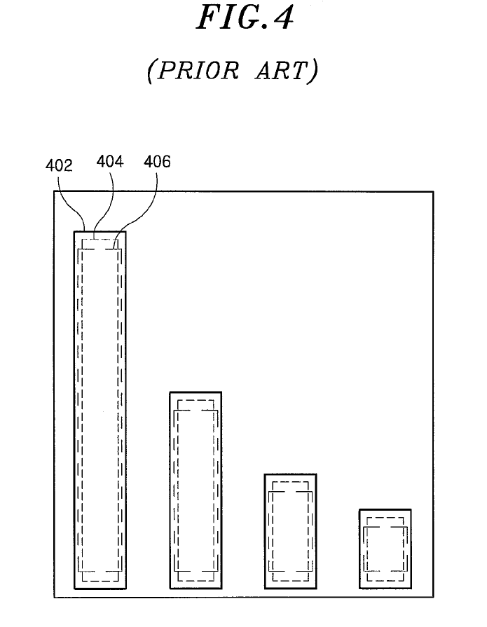

FIG. 4 discloses a layout of a prior art semiconductor wafer. No LDD ion implantation is performed on a NSD or PSD area 402 of the prior art semiconductor wafer because no LDD dummy area is formed in the area where the NSD or PSD area 402 exists. Therefore, the sheet resistance of a poly in the semiconductor wafer of FIG. 4 may become too large relative to design specifications.

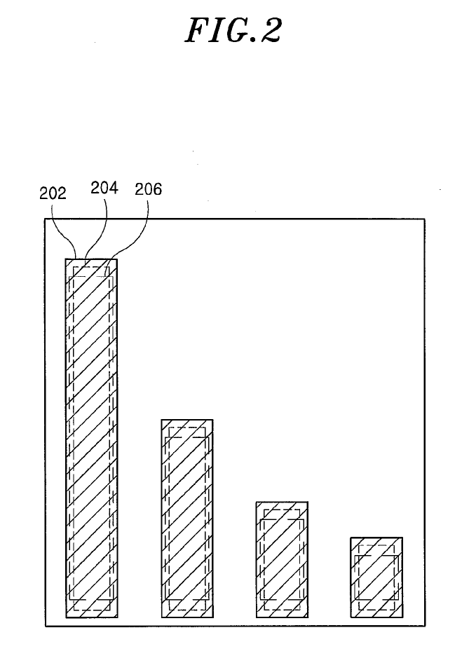

However, in the example embodiment of the present invention described above in connection with FIG. 1, and as disclosed in the example layout of a semiconductor wafer of FIG. 2, an LDD dummy area is programmably generated to correspond to the area where the NSD or PDD area 202 exists. Accordingly, as disclosed in a hatched line in FIG. 2, an LDD dummy area is generated in the area where the NSD or PSD area 202 exists and LDD ion implantation is performed on the LDD dummy area, thereby controlling the sheet resistance of the poly to the sheet resistance in design specifications.

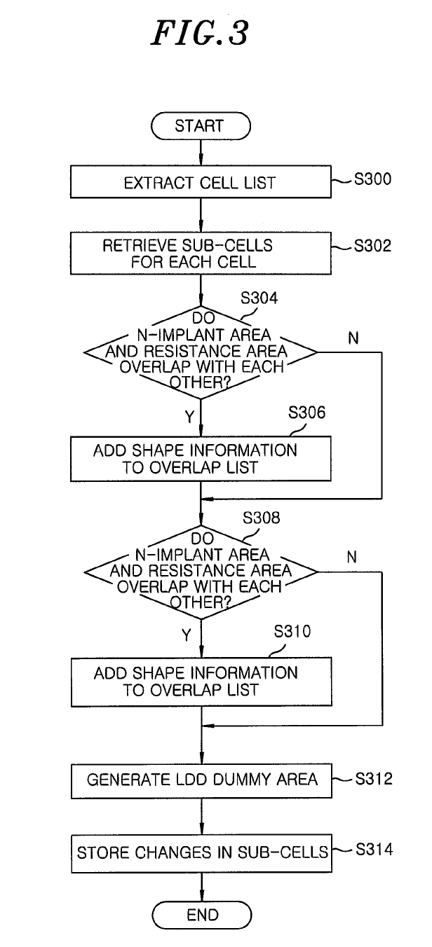

FIG. 3 is an operational control flow chart for explaining in more detail the operation of generating an LDD dummy area in accordance with some example embodiment of the present invention. First, a cell list is extracted from an I/O cell library in order to generate an LDD dummy area (S300). For example, the cell library may include several tens or several hundreds of sub cells such as top metal, process, function, power and the like. Next, all tree-shaped sub-cells are sequentially retrieved for each cell in the cell list (S302), and detection is made whether or not an N-ion implantation area and a resistance area overlap with each other on the layout of a semiconductor wafer (S304). If it is detected that the N-ion implantation area and the resistance area overlap with each other, an indication that corresponds to the detection of such overlap, such as shape information for example, is added to an overlap list (S306). The shape information may include rectangle, path, polygon, and the like and may indicate coordinates, layer name, number of layers, and the like.

Next, sub cells are sequentially retrieved for each cell in the cell list, and detection is made whether or not a P-ion implantation area and a resistance area overlap with each other on the layout of the semiconductor wafer (S308). If it is detected that the P-ion implantation area and the resistance area overlap with each other in the sub-cells, an indication that corresponds to the detection of such overlap, such as shape information for example, is added to an overlap list (S310).

If both of the detections of such overlap are completed by retrieving all of the sub-cells in the cell list, an LDD dummy area is generated in the area where the N-ion implantation area exists and in the area where the P-ion implantation area exists (S312). The LDD dummy area may be generated by being copied from the N-ion implantation area or the P-ion implantation area.

After the generation of the LDD dummy area is completed, a change in the design of the sub-cells is stored (S314), and the I/O library is finished.

Although example embodiments of the present invention have been shown and described, changes might be made to these example embodiments. The scope of the invention is therefore defined in the following claims and their equivalents.

What is claimed is:

1. A method for controlling the sheet resistance of a poly in the fabrication of a semiconductor device, the method comprising:
detecting whether or not an N-ion implantation area and a resistance area overlap with each other within a layout of a cell to be formed on a semiconductor wafer;
generating an LDD dummy area in the area where the N-ion implantation area exists on the layout if such overlap is found;
detecting whether or not a P-ion implantation area and a resistance area overlap with each other within the layout; and
generating an LDD dummy area in the area where the P-ion implantation area exists on the layout if such overlap is found.

2. The method of claim 1, wherein the poly includes a non-salicide poly.

3. A method for controlling the sheet resistance of a poly in the fabrication of a semiconductor device, the method comprising:
extracting a cell list from an I/O cell library;
retrieving all tree-shaped sub-cells of each cell to detect whether or not an ion implantation area and a resistance area overlap with each other; and
generating an LDD dummy area in the area where the ion implantation exists if such overlap is found.

4. The method of claim 3, wherein retrieving all tree-shaped sub-cells of each cell comprises:
retrieving all tree-shaped sub-cells of each cell to detect whether or not an N-ion implantation area and the resistance area overlap with each other; and
retrieving all tree-shaped sub-cells of each cell to detect whether or not a P-ion implantation area and the resistance area overlap with each other.

5. The method of claim 4, wherein generating the LDD dummy area comprises:
generating the LDD dummy area in the area where the N-ion implantation area exists if such overlap is found; and
generating the LDD dummy area in the area where the P-ion implantation area exists if such overlap is found.

6. The method of claim 3, wherein generating the LDD dummy area comprises:
adding an indication that corresponds to the detection of such overlap to an overlap list; and
generating the LDD dummy area in the area where the ion implantation exists.

7. The method of claim 3, wherein the LDD dummy area is generated by being copied from the ion implantation layer.

8. The method of claim 7, wherein the generation of the LDD dummy area is performed before the generation of Mask Data Preparation (MDP).

9. The method of claim 3, wherein the poly comprises a non-salicide poly.
